(19) United States
(12) Patent Application Publication
(10) Pub. No.: US 2026/0081891 A1
(43) Pub. Date: Mar. 19, 2026

(54) DOMAIN NAME SERVER (DNS) PROTOCOL REQUEST TRACKER

(71) Applicant: BANK OF AMERICA CORPORATION, Charlotte, NC (US)

(72) Inventors: John Lozes, Wilmington, DE (US); Amer Ali, Jersey City, NJ (US); Mohammad Saleem Gaziani, Plano, TX (US); Aaron Gee, Palm Coast, FL (US); Aisha Jenkins, Atlanta, GA (US); Tonya Kyra Miller, Charlotte, NC (US); Manonmani Palanichamy, Fort Mill, SC (US); Naresh Kumar Petapalle, Welling (GB); Aravind Singtalur, McKinney, TX (US); Asha Thekkumpurath, Frisco, TX (US); Andrea M. Weisberger, Jacksonville, FL (US)

(73) Assignee: BANK OF AMERICA CORPORATION, Charlotte, NC (US)

(21) Appl. No.: 18/890,629

(22) Filed: Sep. 19, 2024

(51) Int. Cl. H04L 61/4511

(52) U.S. Cl. CPC H04L 61/4511

(57) ABSTRACT

Assisting in the alleviation of Domain Name Service (DNS) request saturation by tracking and identifying DNS queries sent from a server to at least one target server and DNS answers sent from the at least one target server to the server in response to the DNS queries. In response to identifying the DNS queries and DNS answers, (i) destination ports are determined for each DNS answer, with each destination port being associated with a network source, (ii) the network source associated with each destination port is identified, and (iii) the number of connections made between each destination port and the at least one target server is determined. Determining the number of connections between each destination port and the at least one target server can be used, along with DNS caches, to consolidate multiple connections between a destination port and the at least one target server into one persistent connection.

### TECHNOLOGICAL FIELD

The present invention is related generally to assisting the alleviation of Domain Name System (DNS) protocol request saturation and, more specifically, tracking DNS requests to identify problem applications in order to be able to establish persistent connections to reduce DNS request saturation.

### BACKGROUND

Domain Name System (DNS) protocol queries, or, as used herein, DNS requests, are sent to a DNS server from a user system to retrieve an Internet Protocol (IP) address from the DNS server. In certain cases, or certain environments, the same user system may send the same DNS request multiple times. When the same DNS request is made repeatedly, the requests can saturate the DNS server. DNS servers can be overwhelmed or overburdened by DNS request saturation. This can lead to slow response times or disruption of the service, for example. DNS servers, or those entities managing the DNS servers, are not able to identify the source or sources causing or contributing to the DNS request saturation and therefore, cannot effectively handle the DNS request saturation.

Applicant has identified a number of deficiencies and problems associated with reducing DNS request saturation. Therefore, a need exists to develop systems, computerized methods, computer program products and the like that can assist in alleviating DNS request saturation by tracking DNS requests and identifying any problem sources contributing to the DNS request saturation. Through applied effort, ingenuity, and innovation, many of these identified problems have been solved by developing solutions that are included in embodiments of the present disclosure, many examples of which are described in detail herein.

### BRIEF SUMMARY

The following a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide for systems, methods, computer program products and the like that provide for assisting in alleviating Domain Name System (DNS) protocol request saturation. Specifically, the present invention comprises an application that tracks and identifies at least most, it not all, DNS queries from a first server, which may be a user system or user server, to one of at least one target server and then tracks and identifies at least most, if not all DNS answers sent back to the first server from the target server. A target server may be a server that performs network enablement services, such as DNS services or a server that performs functional services, such as Web services. A target server may also host both DNS services and functional services. The application then determines a destination port for each DNS answer sent back to the first server. A destination port is the port to which an answer is sent and each destination port should be associated with a network source, such as an application or process that is initiating the DNS queries. The application identifies the network source associated with each destination port that DNS answers are sent to from one of the at least one target server as well as the number of connections made between each destination port and one of the at least one target server. In some embodiments of the invention, the application further identifies problem network sources, i.e., network sources that are repeatedly sending the same DNS queries to one of the at least one target server. This information can then be used to consolidate multiple connections between a destination port and one of the at least one target server into one persistent connection, thereby alleviating DNS request saturation.

In specific embodiments of the invention, DNS queries and answers are tracked and identified using a packet capture method, where at least most, it not all network traffic data is captured and recorded in a PCAP (Packet CAPture) file and the PCAP file is filtered for DNS queries and answers related to the first server and the DNS queries and answers are recorded. In other embodiments, a local packet capture method that only captures network traffic data related to one server may be used. In further embodiments of the invention, the packet capture method can also include identifying the IP address associated with each DNS answer so that the PCAP file can be searched for connections between the first server and one of the at least one target server using that IP address in order to identify and record the destination port associated with the IP address and the network source associated with the destination port.

In specific embodiments of the invention, the application also displays to a user running the application or managing the DNS server at least most, if not all the DNS queries and answers, the destination ports associated with each DNS answer, the network source associated with each destination port, and the number of connections made between each destination port and one of the at least one the target server. In further embodiments, the application also displays the identified problem network sources. In yet further embodiments, the application generates a text file including at least most, if not all this information.

In specific embodiments of the invention, the application can track and identify DNS queries and answers between multiple servers. In another embodiment of the invention, the application is a Python application.

As such, the present invention provides for assisting in the alleviation of DNS request saturation by tracking DNS requests to identify problem applications or applications with multiple connections in order to be able to establish a persistent connection to reduce DNS request saturation.

A system for assisting in the alleviation of DNS request saturation defines first embodiments of the invention. The system comprises an application that is configured to track and identify at least most, if not, all DNS queries sent from a first server, where the first server may be a user system or user server, to one of at least one target server. In specific embodiments, the target server is one server that performs both DNS services and functional services. In other embodiments, DNS services and functional services may be hosted on separate servers, where the target server hosting DNS services would receive and respond to DNS requests and the first server would establish connections with the target server hosting functionality services. The application also tracks and identifies at least most, if not all, DNS answers sent in response to the DNS queries from one of the at least one target server to the first server. The application then determines a destination port for each DNS answer, where the destination port is the port to which the DNS answer is sent. Each destination port is associated with a network source, i.e., an application or process of the user system that is initiating the DNS queries. The application identifies the network sources associated with all the destination ports to which DNS answers were sent as well as the number of connections made between each destination port and one of the at least one target server.

In specific embodiments of the invention, the application is configured to use a packet capture method to track and identify the DNS queries and DNS answers. The packet capture method comprises capturing at least most, if not, all network traffic data between the first server and one of the at least one target server and recording the network traffic data in a PCAP file. The PCAP file can then be searched or filtered to find at least most, if not, all the DNS queries and DNS answers related to the first server. In specific embodiments, the packet capture method can be used to capture network traffic data across multiple servers. In other embodiments, a local packet capture method may be used to only capture network traffic data related to one server, e.g., the first server. The application then records the DNS queries and DNS answers. In further embodiments, the packet capture method comprises identifying an IP address associated with each DNS answer, where the IP address is the IP address to which the DNS answer was sent. The PCAP file can then be searched for connections using the IP address of each DNS answer and the destination ports and network sources associated with each connection can be identified and recorded. In specific embodiments of the invention, the application can use the recorded information, such as the number of connections, the destination ports and network sources, to identify any problem network sources, where problem network sources are network sources repeatedly sending the same DNS requests to one of the at least one target server.

In specific embodiments of the invention, the application is further configured to display to the user running the application or managing the DNS server at least most, if not, all the DNS queries sent to one of the at least one target server, the DNS answers associated with each DNS query, the destination port associated with each DNS answer, the network source associated with each destination port, and the number of connections made between each destination port and one of the at least one target server. In some embodiments, the application may also display the identified problem network sources. In further embodiments, the application also generates a text file including at least most, if not, all the information displayed. In some embodiments, the application may only generate a text file upon request of the user running the application or managing the DNS server.

In specific embodiments of the invention, the application is configured to track and identify DNS queries and DNS answers between multiple servers. In specific embodiments of the invention, the application is a Python application.

A computer-implemented method for assisting in the alleviation of DNS request saturation defines second embodiments of the invention. The computer-implemented method is executed by one or more computing processor devices. The method comprises tracking and identifying at least most, if not, all DNS queries sent from a first server, where the first server may be a user system, to one of at least one target server as well as tracking and identifying at least most, if not all, DNS answers sent from one of the at least one target server to the first server in response to the DNS queries. In some embodiments of the invention, the target server is one server that performs both DNS services and functional services. In other embodiments, DNS services and functional services may be hosted on separate servers, both of which may be a target server. In specific embodiments of the invention, the method further comprises tracking and identifying DNS queries and DNS answers between multiple servers and not just between one first server and one target server. The method further comprises determining a destination port for each DNS answer, where a destination port is a port of the first server to which the DNS answer is sent. Each destination port is associated with a network source, where a network source may be a process of application that initiated a DNS query. The method further comprises identifying the network sources associated with each destination port to which DNS answers were sent. The method further comprises determining the number of connections made between each destination port and one of the at least one target server. In specific embodiments of the invention, the method further comprises using, at least, the determined or identified destination ports, network sources and/or the number of connections to identify any problem network sources, where a problem network source is a network source is repeatedly sending the same DNS requests or is otherwise contributing to any DNS request saturation experienced by one of the at least one target server. Identifying problem network sources can be of assistance in consolidating multiple connections between a destination port and one of the at least one target server into one persistent connection, thereby alleviating DNS request saturation.

In specific embodiments of the invention, the tracking and identifying DNS queries and DNS answers is done using a packet capture method. The packet capture method includes capturing network traffic data between the first server and one of the at least one target server and recording the network traffic data in a searchable PCAP file. The PCAP file is then searched or filtered for DNS queries and DNS answers sent between the first server and one of the at least one target server and the DNS queries and DNS answers are recorded. In some embodiments, a local packet capture method may be used, such that only network traffic data related to the first server is captured. In further embodiments of the invention, the packet capture method further comprises identifying an IP address associated with each DNS answer. In specific embodiments, the IP address associated with a DNS answer is the IP address to which the DNS answer is sent. The PCAP file is then searched or filtered for connections using the IP addresses associated with each DNS answer and the destination port and network source associated with each connection is recorded.

In specific embodiments of the invention, the method further comprises displaying, and generating a text file including at least most if not all the DNS queries sent from the first server to one of the at least one target server, at least most, if not, all the DNS answers sent from one of the at least one target server to the first server in response to the DNS queries, the destination ports associated with each DNS answer, the network sources associated with each destination port, and the number of connections made between each destination port. In further embodiments, the identified problem network sources are also displayed and included in the generated text file. In some embodiments, the text file is only generated at the request of the user managing one of the at least one target server.

A computer program product including a non-transitory computer-readable medium defines third embodiments of the invention. The computer-readable medium includes sets of codes for causing computing device(s) to track and identify at least most, if not, all DNS queries sent from a first server to one of at least one target server and at least most, if not, all DNS answers sent in response from one of the at least one target server to the first server. In some embodiments of the invention, the target server may be one server that hosts both DNS and functional services. In other embodiments, DNS services and functional services may be hosted on separate servers, in which case, the DNS queries and answers are sent to and from the DNS server and the connections are made with the functionality server. In specific embodiments of the invention, the computer-readable medium also includes sets of codes for causing computing device(s) to track and identify at least most, if not, all DNS queries and DNS answers between multiple servers. The computer-readable medium also includes sets of codes for causing computing device(s) to determine a destination port for each DNS answer, where the destination port is a port of the first server to which the DNS answer was sent. Each destination port is associated with a network source, which may be a process or application that initiated a DNS query that was sent to one of the at least one target server. The computer-readable medium also includes sets of codes for causing computing device(s) to identify the network sources associated with each destination port and to determine the number of connections made between each destination port and one of the at least one target server. In further embodiments of the invention, the computer-readable medium also includes sets of codes for causing computing device(s) to identify a problem network source based at least on the number of connections between each destination port and the target network. A problem network source would be any network source that is repeatedly sending DNS queries to one of the at least one target server or is otherwise contributing to DNS request saturation of one of the at least one target server. In this way, by determining the number of connections between each destination port and one of the at least one target server or by further identifying problem network sources, multiple connections between a destination port and one of the at least one target server can be consolidated into one persistent connection, which would reduce DNS request saturation.

In specific embodiments of the invention, the computer-readable medium also includes sets of codes for causing computing device(s) to use a packet capture method to track and identify DNS queries and DNS answers related to the first server. The packet capture method comprises capturing network traffic data and filtering for network traffic data between the first server and one of the at least one target server. In some embodiments, network traffic data between multiple servers may be recorded. In other embodiments, a local packet capture method may be used to only capture network traffic data related to one server, e.g., the first server. The network traffic data is recorded in a PCAP file. The PCAP file is then searched or filtered for DNS queries and DNS answers and the DNS queries and the DNS answers are recorded. In further embodiments of the invention, the packet capture method further comprises identifying an IP address associated with each DNS answer. In specific embodiments of the invention, the IP address associated with a DNS answer is the IP address to which the DNS answer was sent. The PCAP file is then searched or filtered for connections using the IP addresses associated with each DNS answer and the network source and destination port associated with each connection is recorded.

In further embodiments of the invention, the computer-readable medium also includes sets of codes for causing computing device(s) to display, and generate a text file including at least most, if not all, the DNS queries and DNS answers recorded from the PCAP file, the destination ports associated with each DNS answer, the network sources associated with each destination port and the number of connections between each destination port and one of the at least one target server. In specific embodiments of the invention, the computer-readable medium also includes sets of codes for causing computing device(s) to display and generate a text file including the identified problem network sources. In some embodiments of the invention, the text file is only generated upon request of a user managing at least one target server.

Thus, according to embodiments of the invention, which will be discussed in greater detail below, the present invention provides for assisting in the alleviation of DNS request saturation. Specifically, the invention allows for tracking and identifying DNS queries sent from a first server to one of at least one target server and further tracking and identifying the DNS answers sent from one of the at least one target server to the first server to identify the specific destination port of the first server to which the DNS answer was sent. The target server may be one server that hosts both DNS services and functional service, or DNS services and functional services may be hosted on separate servers, both of which would be target servers, with the first receiving and responding to DNS queries and the second being the server that maintains connections. The invention allows for the identification of the network source associated with each destination port to which a DNS answer was sent, where a network source may be a process or application that initiated the DNS query sent to one of the at least one target server. The invention also allows for determining the number of connections between each destination port and one of the at least one target server. In some embodiments, the invention also provides for identifying problem network sources, where a problem network source may be a network source that is repeatedly sending DNS queries to one of the at least one target server or is otherwise contributing to DNS request saturation. In specific embodiments, the invention provides for DNS queries and DNS answers to be tracked using a packet capture method, which comprises capturing all network traffic data, filtering for network traffic data between the first server and one of the at least one target server, recording the filtered network traffic data in a PCAP file, and searching the PCAP file for DNS queries and DNS answers to then record the DNS queries and DNS answers. In some embodiments, the packet capture method may be used to capture network traffic data across multiple servers, without filtering for data related to the first server. In other embodiments, a local packet capture method may be used to only capture network traffic data related to the first server, instead of having to filter for it. In further embodiments, packet capture method further comprises identifying the IP addresses to which each DNS answer was sent, searching the PCAP file for connections using the IP addresses and recording the network source and destination port associated with each connection. In further embodiments, the invention also provides for displaying, and generating a text file including at least most, if not, all the DNS queries, the DNS answers associated with each DNS query, the destination port associated with each DNS answer, the network source associated with each destination port, and the number of connections between each destination port and one of the at least one target server. In some embodiments, the invention also provides for displaying, and generating a text file including the identified problem network sources. In this way, by determining the number of connections between the destination ports and one of the at least one target server and identifying problem network sources, the invention assists in the alleviation of DNS request saturation by allowing for multiple connections between a destination port and one of the at least one target server to be consolidated into one persistent connection.

The above summary is provided merely for purposes of summarizing some example embodiments to provide a basic understanding of some aspects of the present disclosure. The features, functions, and advantages that have been discussed may be achieved independently in various embodiments of the present invention or may be combined with yet other embodiments, further details of which can be seen with reference to the following description and drawings. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for assisting in the alleviation of Domain Name Service (DNS) request saturation, in accordance with an embodiment of the disclosure;

FIG. 2 illustrates a process flow for assisting in the alleviation of DNS request saturation by tracking DNS requests, in accordance with an embodiment of the disclosure; and

FIG. 3 illustrates a process flow for assisting in the alleviation of DNS request saturation by tracking DNS requests using a packet capture method.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of method or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, light-emitting diode (LED), light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration. ” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “satisfying the threshold” or “meeting the threshold” may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

According to embodiments of the invention, which will be described in more detail below, systems, methods and computer program products are disclosed that provide for assisting in the alleviation of Domain Name Service (DNS) request saturation. Specifically, the invention tracks DNS queries and DNS answers and identifies problem network sources that repeatedly send the same DNS query to one of the at least one target server so that multiple connections between the destination port associated with the problem network source and one of the at least one target server can be consolidated into one persistent connection such that DNS request saturation of at least one target server is reduced.

DNS requests are sent from user systems or user servers to target servers to retrieve from the target servers an IP address and establish a connection to the target server. Sometimes, the same source in a user system may send the same DNS request multiple times or repeatedly to the target server, which can overwhelm the target server. This is DNS request saturation. DNS request saturation can result in disruption of services provided by the server or slower response times, among other problems. To reduce DNS request saturation, the sources sending the repeated requests need to be identified so that the multiple connections made from the multiple DNS requests can be consolidated into one persistent connection to reduce the burden on the target server.

The present invention identifies problem network sources that may be contributing to DNS request saturation by tracking DNS queries and DNS answers sent between a first user server and at least one target server, where the target server may be one server that hosts both DNS services and functional services or separate target servers for DNS services and functional services. By tracking DNS queries from the first server, the invention can then track DNS answers sent from one of the at least one target server back to the first server to identify the destination ports the DNS answers are sent to. By identifying the destination ports the DNS answers are sent to, the invention can identify the network source initiating the DNS queries associated with the destination port as well as the number of connections between the destination port and one of the at least one target server, which in turn can help identify the problem network sources.

Accordingly, the present disclosure comprises an application that tracks and identifies at least most, if not all, DNS queries from a first server to at least one target server and then tracks and identifies at least most, if not, all DNS answers sent back to the first server from one of the at least one target server. The application then determines a destination port for each DNS answer sent back to the first server. A destination port is the port to which an answer is sent, and each destination port should be associated with a network source, such as an application or process that is initiating the DNS queries. The application identifies the network source associated with each destination port that DNS answers are sent to from one of the at least one target server as well as the number of connections made between each destination port and one of the at least one target server. In some embodiments of the invention, the application further identifies problem network sources, i.e., network sources that are repeatedly sending the same DNS queries to one of the at least one target server. This information can then be used to consolidate multiple connections between a destination port and one of the at least one target server into one persistent connection, thereby alleviating DNS request saturation.

In specific embodiments of the disclosure, DNS queries and answers are tracked and identified using a packet capture method, where at least most, if not, all network traffic data is captured and recorded in a Packet CAPture (PCAP) file and the PCAP file is filtered for DNS queries and answers related to the first server and the DNS queries and answers are recorded. In further embodiments of the invention, the packet capture method can also include identifying the IP address associated with each DNS answer so that the PCAP file can be searched for connections using that IP address in order to identify and record the destination port associated with the IP address and the network source associated with the destination port.

In specific embodiments of the disclosure, the application also displays to a user running the application or managing the DNS server at least most, if not, all the DNS queries and answers, the destination ports associated with each DNS answer, the network source associated with each destination port, and the number of connections made between each destination port and one of the at least one target server. In further embodiments, the application also displays the identified problem network sources. In yet further embodiments, the application generates a text file including at least most, if not, all this information.

In specific embodiments of the disclosure, the application can track and identify DNS queries and answers between multiple servers. In another embodiment of the disclosure, the application is a Python application.

What is more, the present disclosure provides a technical solution to a technical problem. As described herein, the technical problem includes DNS servers being overwhelmed by DNS requests, i.e., DNS request saturation. The technical solution presented herein allows for identifying sources that cause or contribute to the DNS request saturation so that some of the burden may be taken off the DNS server by consolidating multiple connections resulting from multiple of the same DNS requests into one persistent connection. In particular, an invention that provides for identifying sources contributing to DNS request saturation is an improvement over existing solutions to the problem of DNS servers being overwhelmed or inundated with repeated DNS requests, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

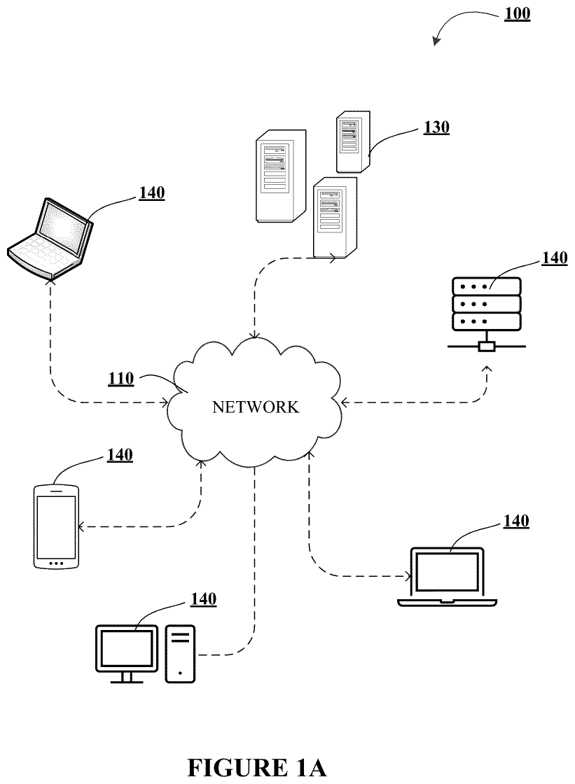

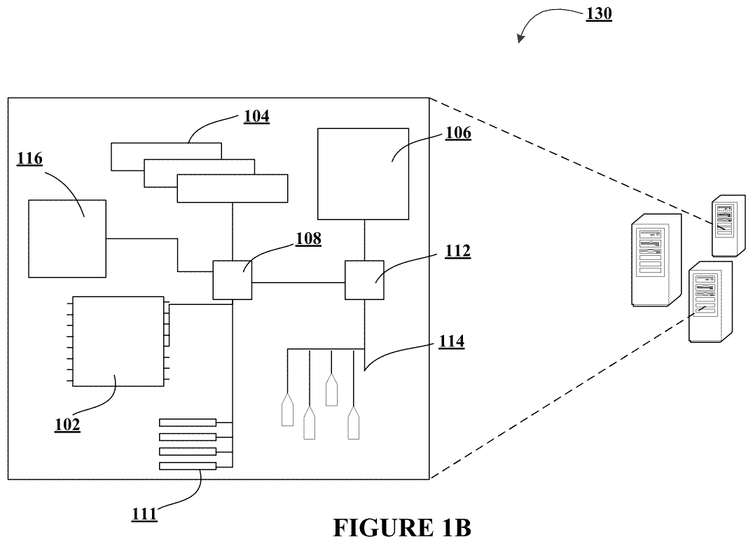

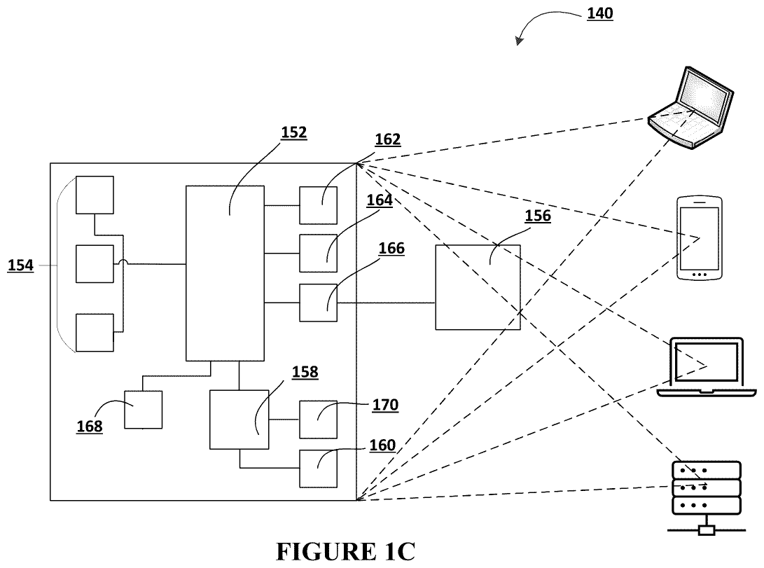

FIGS. 1A-1C illustrate technical components of an exemplary distributed computing environment for assisting in the alleviation of DNS request saturation by tracking DNS requests 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low-speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or include a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also include instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low-speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product includes instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, including communication methods for data that remains within a single network segment (link); the Internet layer, providing internetworking between independent networks; the transport layer, handling host-to-host communication; and the application layer, providing process-to-process data exchange for applications. Each layer includes a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

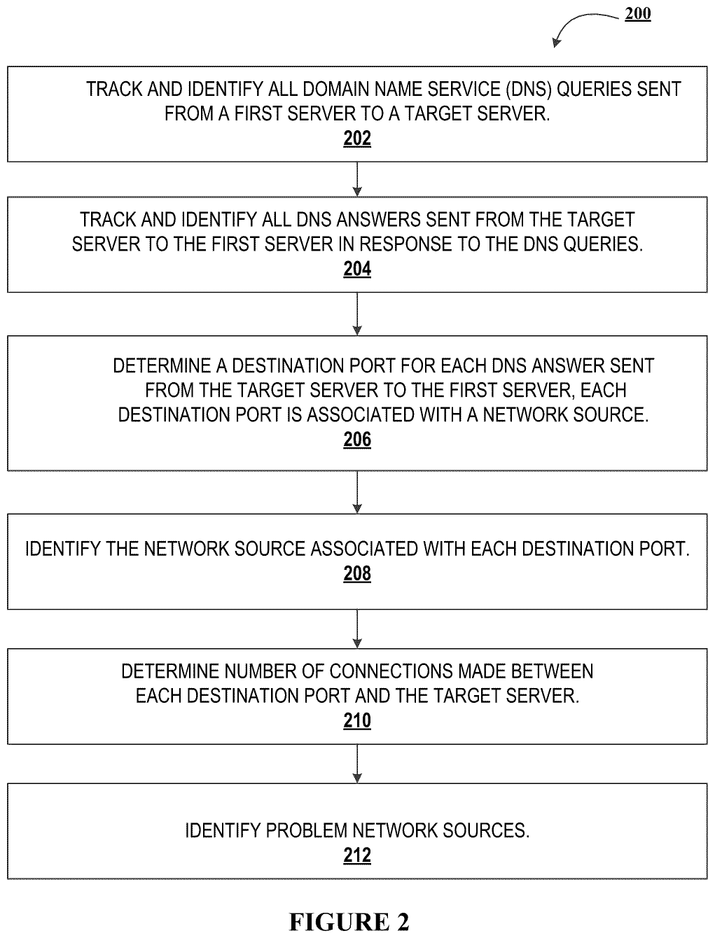

FIG. 2 illustrates a process flow 200 for determining the number of connections between at least one target server and the various destination ports of a first server. Block 202 represents tracking and identifying at least most, if not all, DNS queries sent from a first server to at least one target server. In some embodiments of the invention, one target server hosts both DNS services and functional services. In other embodiments of the invention, there may be multiple target servers, where DNS services and functional services are hosted on separate target, and the server hosting DNS services receives and responds to DNS queries and the server hosting functional services maintains connections with the first server. Block 204 represents tracking and identifying at least most, if not, all DNS answers sent from one of the at least one target server to the first server in response to the DNS queries. In some embodiments of the invention, DNS queries and DNS answers between multiple servers can be tracked and identified. Block 206 represents determining a destination port for each DNS answer sent from one of the at least one target server to the first server. The destination port is a port of the first server to which the DNS answer was sent. Each destination port is associated with a network source, where a network source may be a particular process or application that is sending one or more of the DNS queries to one of the at least one target server. Block 208 represents identifying the network sources associated with each destination port. Block 210 represents determining the number of connections made between each destination port and one of the at least one target server. The determined number of connections between each destination port and one of the at least one target server can be used, along with DNS caches, to consolidate multiple connections between a destination port and one of the at least one target server into one persistent connection. In some embodiments of the invention, problem network sources, which are network sources that repeatedly send the same DNS requests or otherwise contribute to DNS request saturation may also be identified, as represented in Block 212.

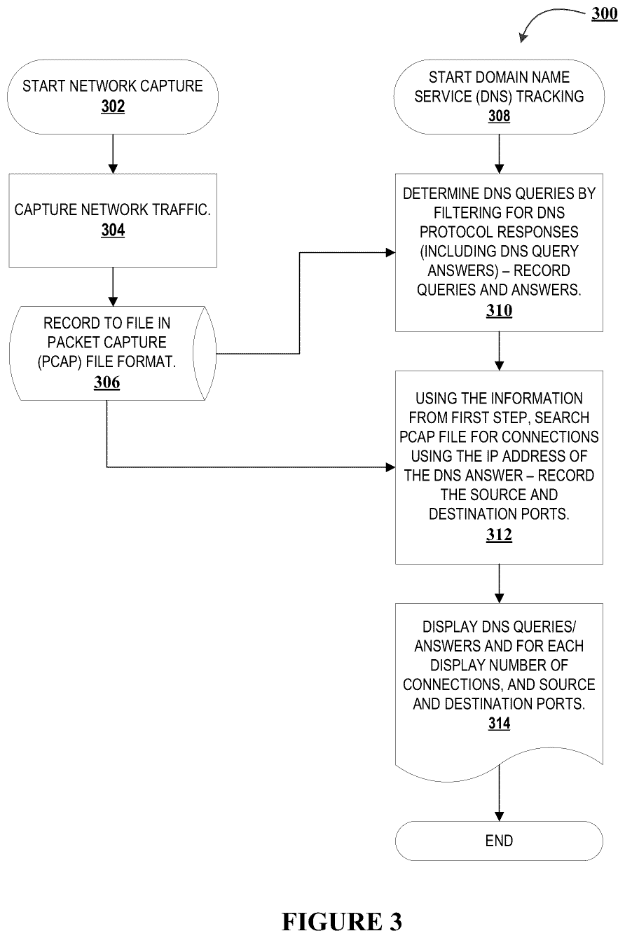

FIG. 3 illustrates a process flow for specific embodiments of the invention for tracking DNS queries, DNS answers, identifying destination ports and network sources, and determining number of connections using a packet capture method. The packet capture method includes two parts. The first part is the network capture part, the start of which is represented by Block 302. The second part is the DNS tracking part, the start of which is represented by Block 308. Network capture comprises first capturing at least most, if not all, network traffic, as represented by Block 304. Network capture then comprises filtering the captured data for network traffic data between the first server and one of the at least one target server and recording the filtered network traffic data in a PCAP file format, as represented by Block 306. In some embodiments of the invention, the network capture process may be repeated between multiple servers to capture the network traffic data between multiple servers. In further embodiments of the invention, a local packet capture method may be used to only capture the network traffic data between the first server and one of the at least one target server, without having to filter for it, and recording such data in a PCAP file directly.

DNS tracking first comprises filtering the PCAP file for DNS protocol responses that includes DNS answers and recording at least most, if not, all DNS queries and DNS answers, as represented in Block 310. DNS tracking further comprises, using the DNS queries and DNS answers to search the PCAP file for connections using the IP addresses to which the DNS answers were sent and recording the destination ports and network sources associated with each of the IP addresses, as represented in Block 312. Finally, DNS tracking comprises displaying at least most, if not, all DNS queries and DNS answers, as well as displaying the destination ports associated with each DNS answer, the network sources associated with each destination port, and the number of connections between each destination port and one of the at least one target server, as represented by Block 314.

Thus, present embodiments of the invention discussed in detail above, the present invention provides for assisting in the alleviation of DNS request saturation. Specifically, the invention allows for tracking and identifying DNS queries sent from a first server to at least one target server and further tracking and identifying the DNS answers sent from one of the at least one target server to the first server to identify the specific destination port of the first server to which the DNS answer was sent. In some embodiments, there is one target server that hosts both DNS services and functionality services. In other embodiments, DNS services and functionality services may be hosted on separate servers, each being a target server. In that case, the target server hosting DNS services would receive and respond to DNS queries and the target server hosting functionality services would be the server with which the first server makes connections. The invention allows for the identification of the network source associated with each destination port to which a DNS answer was sent, where a network source may be a process or application that initiated the DNS query sent to one of the at least one target server. The invention also allows for determining the number of connections between each destination port and one of the at least one target server. In some embodiments, the invention also provides for identifying problem network sources, where a problem network source may be a network source that is repeatedly sending DNS queries to one of the at least one target server or is otherwise contributing to DNS request saturation. In specific embodiments, the invention provides for DNS queries and DNS answers to be tracked using a packet capture method, which comprises capturing network traffic data, filtering for network traffic data between the first server and one of the at least one target server, recording the filtered network traffic data in a PCAP file, and searching the PCAP file for DNS queries and DNS answers to then record the DNS queries and DNS answers. In some embodiments, a local packet capture method may be used to capture only network traffic data related to the first server. In further embodiments, packet capture method further comprises identifying the IP addresses to which each DNS answer was sent, searching the PCAP file for connections using the IP addresses and recording the network source and destination port associated with each connection. In further embodiments, the invention also provides for displaying, and generating a text file including at least most, if not, all the DNS queries, the DNS answers associated with each DNS query, the destination port associated with each DNS answer, the network source associated with each destination port, and the number of connections between each destination port and one of the at least one target server. In some embodiments, the invention also provides for displaying, and generating a text file including the identified problem network sources. In this way, by determining the number of connections between the destination ports and one of the at least one target server and identifying problem network sources, the invention assists in the alleviation of DNS request saturation by allowing for multiple connections between a destination port and one of the at least one target server to be consolidated into one persistent connection.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for assisting the alleviation of Domain Name Service (DNS) request saturation, the system comprising an application configured to:
track and identify DNS queries sent from a first server to at least one target server;
track and identify DNS answers sent from the at least one target server to the first server in response to the DNS queries;
determine a destination port for each DNS answer sent from the at least one target server to the first server, wherein each destination port is associated with a network source;
identify the network source associated with each destination port, wherein each network source may be a particular process or application that is sending one or more DNS queries; and
determine a number of connections made between each destination port and the at least one target server, wherein determining the number of connections between each destination port and the at least one target server can be used, along with DNS caches, to consolidate multiple connections between a destination port and the at least one target server into one persistent connection.

2. The system of claim 1, wherein the application is further configured to use a packet capture method to track and identify DNS queries and DNS answers, the packet capture method comprising:
capturing network traffic data;
recording the network traffic data in a Packet CAPture (PCAP) file;
searching the PCAP file for DNS queries and DNS answers; and
recording the DNS queries and DNS answers.

3. The system of claim 2, wherein the packet capture method further comprises:
identifying an IP address associated with each DNS answer;
searching the PCAP file for connections using the IP address of each DNS answer; and
recording the network source and destination port associated with each connection.

4. The system of claim 1, wherein the application is further configured to identify problem network sources, wherein each network source is evaluated and determined to either be a problem network source or not based at least on the number of connections between the destination port associated with the network source and the at least one target server.

5. The system of claim 1, wherein the application is further configured to track and identify DNS queries and answers between multiple servers.

6. The system of claim 1, wherein the application is further configured to display and generate a text file including the following:
the DNS queries sent from the first server to the at least one target server;
for each DNS query, the DNS answer sent in response;
for each DNS answer, the associated destination port;
for each destination port; the associated network source; and
the number of connections made between each destination port and the at least one target server.

7. The system of claim 6, wherein the application is further configured to display and generate a text file including the identified problem network sources.

8. The system of claim 1, wherein the application is a Python application.

9. A computer implemented method for assisting the alleviation of Domain Name System (DNS) request saturation, the method comprising:
tracking and identifying DNS queries sent from a first server to at least one target server;
tracking and identifying DNS answers sent from the at least one target server to the first server in response to the DNS queries;
determining a destination port for each DNS answer sent from the at least one target server to the first server, wherein each destination port is associated with a network source;
identifying the network source associated with each destination port, wherein each network source may be a particular process or application that is sending one or more DNS queries; and
determining a number of connections made between each destination port and the at least one target server, wherein determining the number of connections between each destination port and the at least one target server can be used, along with DNS caches, to consolidate multiple connections between a destination port and the at least one target server into one persistent connection.

10. The computer implemented method of claim 9, wherein the method further comprises using a packet capture method to track and identify DNS queries and DNS answers, the packet capture method comprising:
capturing network traffic data;
recording the network traffic data in a PCAP file;
searching the Packet CAPture (PCAP) file for DNS queries and DNS answers; and
recording the DNS queries and DNS answers.

11. The computer implemented method of claim 10, wherein the packet capture method further comprises:
identifying an IP address associated with each DNS answer;
searching the PCAP file for connections using the IP address of each DNS answer; and
recording the network source and destination port associated with each connection.

12. The computer implemented method of claim 9, wherein the method further comprises identifying problem network sources, wherein each network source is evaluated and determined to either be a problem network source or not based at least on the number of connections between the destination port associated with the network source and the at least one target server.

13. The computer implemented method of claim 9, wherein the method further comprises tracking and identifying DNS queries and answers between multiple servers.

14. The computer implemented method of claim 12, wherein the method further comprises displaying and generating a text file including at least one of the following:
the DNS queries sent from the first server to the at least one target server;
for each DNS query, the DNS answer sent in response;
for each DNS answer, the associated destination port;
for each destination port; the associated network source;
the number of connections made between each destination port and the at least one target server; and
the identified problem network sources.

15. A computer program product for assisting the alleviation of DNS request saturation, the computer program product comprising at least one non-transitory computer-readable medium having computer-readable code portions embodied therein, the computer readable code portions comprising:
an executable code portion configured to track and identify DNS queries sent from a first server to at least one target server;
an executable code portion configured to track and identify DNS answers sent from the at least one target server to the first server in response to the DNS queries;
an executable code portion configured to determine a destination port for each DNS answer sent from the at least one target server to the first server, wherein each destination port is associated with a network source;
an executable code potion configured to identify the network source associated with each destination port, wherein each network source may be a particular process or application that is sending one or more DNS queries; and
an executable code portion configured to determine a number of connections made between each destination port and the at least one target server, wherein determining the number of connections between each destination port and the at least one target server can be used, along with DNS caches, to consolidate multiple connections between a destination port and the at least one target server into one persistent connection.

16. The computer program product of claim 15, wherein the computer program product further comprises an executable code portion configured to use a packet capture method to track and identify DNS queries and DNS answers, the packet capture method comprising:
capturing network traffic data;
recording the network traffic data in a PCAP file;
searching the PCAP file for DNS queries and DNS answers; and
recording the DNS queries and DNS answers.

17. The computer program product of claim 16, wherein the packet capture method further comprises:
identifying an IP address associated with each DNS answer;
searching the PCAP file for connections using the IP address of each DNS answer; and
recording the network source and destination port associated with each connection.

18. The computer program product of claim 15, wherein the computer program product further comprises an executable code portion configured to identify problem network sources, wherein each network source is evaluated and determined to either be a problem network source or not based at least on the number of connections between the destination port associated with the network source and the at least one target server.

19. The computer program product of claim 15, wherein the computer program product further comprises an executable code portion configured to track and identify DNS queries and answers between multiple servers.

20. The computer program product of claim 18, wherein the computer program product further comprises an executable code portion configured to display and generate a text file including at least one of the following:
the DNS queries sent from the first server to the at least one target server;
for each DNS query, the DNS answer sent in response;
for each DNS answer, the associated destination port;
for each destination port, the associated network source;
the number of connections made between each destination port and the at least one target server; and
the identified problem network sources.
